(19) United States
(12) Patent Application Publication
(10) Pub. No.: US 2009/0148700 A1
(43) Pub. Date: Jun. 11, 2009

(54) Method for Making a Composite RTM Part and Composite Connecting ROD Obtained by Said Method

(76) Inventor: Frederick Cavaliere, Montigny Le Bretonneux (FR)

Correspondence Address: FULBRIGHT & JAWORSKI, LLP, 666 FIFTH AVE, NEW YORK, NY, 10103-3198, US

(21) Appl. No.: 11/991,984

(22) PCT Filed: Sep. 12, 2006
(86) PCT No.: PCT/FR2006/002102

§ 371 Date: May 22, 2008

(30) Foreign Application Priority Data
Sep. 12, 2005 (FR) 0552745

(51) Int. Cl. B32B 1/08; F16C 7/00; B29C 45/00

(52) U.S. Cl. 428/376; 74/579 R; 264/328.5

(57) ABSTRACT

The invention mainly concerns a method for making a composite RTM part (23) which consists in producing a dry fibrous preform (8) by inserting in said dry preform (8) composite parts (10, 11) made of prepregs. Said parts, pre-impregnated with a first resin, are partly polymerized. The assembly is placed in a mold (16). A second resin is injected into the mold and impregnates the dry fibers (7). The two resins are polymerized simultaneously. The partial polymerization of the pre-impregnated parts (10, 11) results in a good chemical bonding between the two resins. The pre-impregnated parts (10, 11) have better mechanical properties, in particular in compression, than RTM parts. This is particularly due to a better alignment of the fibers (12) in the direction of stresses, and to a higher fiber volume ratio. The final component (23), reinforced with pre-impregnated parts, has better mechanical properties than the same RTM component without pre-impregnated reinforcements, in particular in compression. The invention also concerns a connecting rod obtained by said method.

The invention pertains to a method for the manufacture of an RTM (resin transfer molding) composite part and a composite part obtained according to this method. The invention is aimed at improving the mechanical characteristics of such a part under compression. The invention can be applied to particular advantage in tubular parts such as composite connection rods. These parts can be used especially in the automobile or aeronautical field.

There are two known methods used to manufacture tubular composite parts: the RTM method and the pre-impregnation method.

In the RTM method, a set of fibrous elements is positioned in a particular way about a support. This set of fibrous elements forms an RTM preform. Each fibrous element has dry fibers which are generally interlaced or parallel to each other. The RTM preform and the support are then put into a mold into which a resin is injected. The injection of resin can be done under vacuum or under pressure. The resin is then polymerized by the addition of energy to it. The molecules of this resin then begin to bond with one other and form a solid netting. Thus, a rigid and light composite material is obtained, formed by fibers and polymerized resin.

The RTM method has the advantage of great flexibility, enabling the making of parts having complex geometry. Indeed, since the fibers are dry at the outset, they can be put into place more easily to take the shape of any support whatsoever. In one example, to make a tubular part, the fibrous elements possess the shape of a stocking placed about a tubular support (a chuck) made of foam material for example.

The RTM method when implemented also has the advantage of being able to integrate functions, especially assembling functions. Indeed, the possibility of making complex-shaped parts averts the need to make several parts of a less complex shape and subsequently assemble them.

However, in the RTM method, the fibers are not very well aligned. Indeed, since the fibers of the preform are dry, they can easily change orientation because of the presentation of the fibrous elements or during handling operations such as for example operations for making the preform and putting the preform into a mold or during the injection of the resin. The fibers can thus be located in a direction different from the one initially planned which, for example, was the direction of the compression forces.

In one mode of implementation of the RTM method, it was sought to make a fiber preform using interlaced dry fibers and dry fibers parallel to one another. The interlaced dry fibers were intended to support the buckling stresses while the parallel fibers were aimed at supporting the compressive stresses. However, in reality, the parallel fibers, held by means of an elastic frame, showed disorientation by some degrees relative to the direction of the main compressive stresses. After polymerization, the mechanical characteristics of the part obtained, in terms of rigidity and compressive strength, were not the ones planned. The part obtained therefore was unable to support the expected compressive stresses. Indeed, the fibers underwent local buckling stresses because of the alignment and imperfect orientation relative to the direction of the forces.

Furthermore, in the RTM method, the volume rate of fibers is not very great. It generally ranges from 45% to 55%. This volume rate corresponds to the ratio between the volume of fibers and the general volume of the part. The mechanical characteristics of the parts made by RTM are therefore on the whole not exceptional in terms of compression.

There is also the pre-impregnation method in which pre-impregnated strips or folds are used. These pre-impregnated strips comprise pre-impregnated resin fibers made of resin which are aligned and parallel with one another. These fibers are thus bonded to one another and held parallel to one another by means of this resin. Unlike the fibers used in the RTM method, the fibers of the strips are therefore not dry at the outset and are very well aligned and have very high parallelism with one another.

The pre-impregnated parts are obtained by the stacking of pre-impregnated strips and are polymerized under pressure. The parts obtained with this method have a substantial volume rate of fibers of over 55%. The parts obtained with such a method therefore have very good mechanical characteristics, especially under compression, in the direction of the main orientation of the pre-impregnated fibers.

However, the pre-impregnation method has drawbacks and in particular cannot be used for the easy manufacture of parts with complex geometry such as for example connection rod ends. Indeed, the use of pre-impregnated strips is ill-suited to closed-ended geometries because the pre-impregnated strips take a flat shape and it is very difficult to communicate shapes having several radii of curvature to these strips. For parts with complex geometry such as the ends of connection rods, it may therefore be difficult to obtain high compaction of the part during polymerization. The pre-impregnated parts can therefore have poor material worthiness, leading to a high discard rate.

The invention proposes to eliminate the drawbacks of the RTM method and of the pre-impregnation method while at the same time benefiting from their respective advantages. To this end, the invention combines the implementation of these two methods in a particular way.

More specifically, the invention consists in obtaining composite parts by the introduction into an RTM preform of pre-impregnated parts that have been pre-polymerized in part. The method of the invention thus enables the making of parts with complex geometry in using preforms made by the RTM method and improving the mechanical characteristics under compression of these complex parts in introducing pre-impregnated parts and pre-polymerized parts into the preform.

Indeed, the insertion of pre-impregnated parts locally contributes high alignment of fibers and a high volume rate of the fibers within the part made by RTM. Furthermore, the fact of partially polymerizing the resin of the pre-impregnated parts makes it possible to fix the alignment of the fibers and especially prevents these fibers from moving during a handling operation or during the polymerization of the RTM resin.

Partial polymerization also enables the creation of chemical bonds between the molecules of the resin of the pre-impregnated part and those of the RTM resin during the polymerization of the RTM resin. This creation of bonds rigidifies the final composite material and gives this material high homogeneity.

The pre-impregnated and pre-polymerized parts have a generally simplified geometry. This simplified geometry is used to obtain high compaction during their making and therefore high material worthiness. These pre-impregnated and pre-polymerized parts are inserted for a structural purpose. Indeed, these parts are generally placed at positions where the compressive forces to be supported are great and where the geometry of the part is simple. In one particular embodiment, the RTM fiber preform is made to take the complex shape of a connection rod while the pre-impregnated parts are positioned in the preform at the places where the compressive forces are the most intense.

Preferably, the necessary number of pre-impregnated and pre-polymerized parts is made in shaping a stack of pre-impregnated strips on a specific tool and in partially polymerizing the resin of these strips. As a variant, the pre-impregnated parts are made directly on the support used to make the RTM preform. These pre-impregnated parts may undergo cutting and machining operations before they are introduced into the RTM preform.

In the invention, the pre-impregnated and pre-polymerized parts are positioned either directly on the support enabling the making of the preform or inserted between the dry fiber elements of the RTM preform.

The invention therefore relates to a method for the manufacture of an RTM composite part characterized in that it comprises the following steps:
a pre-impregnated part is made, this part comprising substantially aligned fibers, these fibers being impregnated with a first resin,
the first resin alone of the pre-impregnated part is subjected to a first step of partial polymerization up to a stage such that the first resin is rigid enough for the fibers to be fixed in their position inside said resin,
the pre-polymerized part and a dry fibrous preform are positioned about a support, the preform comprising fibrous elements, these fibrous elements comprising dry fibers,
a second resin is injected into the fibrous preform, and
in a second polymerization step, the second resin is polymerized and the polymerizing of the first resin is terminated simultaneously.

The invention also relates to a connection rod made of composite material comprising a preferred axis of compression, characterized in that it comprises:
at least two layers of fibrous elements comprising interlaced fibers impregnated with resin after shaping by the RTM method, and
parts made of composite material using pre-impregnated resin fibers and positioned between the layers of fibrous elements, said parts comprising fibers that are substantially parallel to one another, these fibers being oriented substantially along the preferred axis of compression of the connection rod.

The invention will be understood more clearly from the following description and the accompanying figures. These figures are given only by way of an illustration and in no way restrict the scope of the invention. Of these figures:

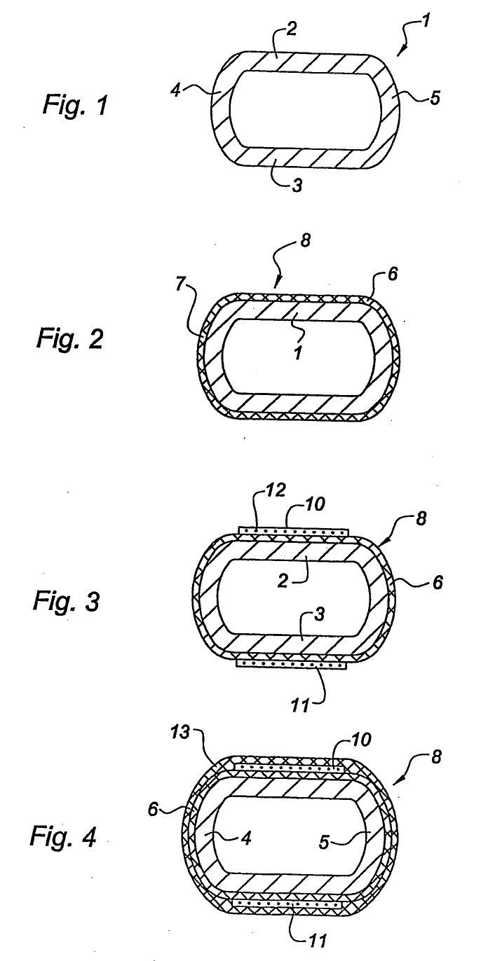

FIGS. 1 to 6 are schematic views of steps of the method according to the invention;

FIG. 7 is a schematic view of steps for obtaining the pre-impregnated and pre-polymerized parts.

FIG. 1 is a sectional view of a chuck or support 1 designed to impose a shape on a final composite part. Indeed, this support 1 is the tool used to make an RTM preform. This support 1 is tubular, elongated and generally has the shape of a connection rod.

More specifically, seen in a sectional view, this support 1 has two faces 2 and 3 that are flat facing one another and parallel to each other. These faces 2 and 3 are connected to each other by means of two faces 4 and 5 which are circular and on the whole have the shape of a circle arc.

In a particular embodiment, the support 1 is made of metal, foam material or elastomer.

FIG. 2 shows a first step of the method according to the invention in which the first fibrous elements 6 are placed flat around the support 1 against the external faces of this support 1. These first fibrous elements 6 have dry fibers 7 that are interlaced with each other.

These dry fibers 7 can be interlaced so as to form angles of plus or minus 45% with the axis of the part. In one embodiment, the elements 6 have a closed stocking shape. These stockings are deformable and precisely take the shape of the support 1.

A dry preform 8 comprising the fibrous elements 6 is thus formed about the support 1. In one embodiment, this preform 8 is formed out of a number of fibrous elements greater than or equal to 2.

To slightly rigidify the preform 8, it is possible to deposit a resin in powder form or as a spray between the layers of dry fibrous elements and to compact the entire preform.

As a variant, the dry fibers 7 mutually form angles of different values and could even be on the whole parallel to them.

FIG. 3 shows a second step of the method of the invention. In this second step, two pre-impregnated and pre-polymerized parts 10 and 11, having a shape that is on the whole plane, are positioned on the dry preform 8 above the plane faces 2 and 3 of the support 1.

The parts 10 and 11 have fibers 12 which are taken within a first pre-polymerized resin. These fibers 12 have an almost perfect alignment inside the parts 10 and 11 and are parallel to each other. The parts 10 and 11 are positioned so that the fibers 12 have an orientation perpendicular to the plane of the sheet, in the direction of elongation of the support 1, i.e. in the direction of the compressive forces that will be applied to the final part. FIGS. 7a and 7b provide a detailed explanation of the way in which the parts 10 and 11 are obtained.

As a variant, the parts 10 and 11 have a slightly curved shape at their ends and thus partly take the shape of the faces 4, 5.

FIG. 4 shows a third step of the method of the invention in which the second fibrous elements 13 are positioned about first fibrous elements 6 and parts 10 and 11. These second elements 13 preferably have a stocking shape, like the first elements 6.

The dry preform 8 then has a first layer and a second layer of fibrous elements 6 and 13 between which the parts 10 and 11 have been introduced.

Here again, it is possible to deposit resin again in power form or as a spray in order to further rigidify the preform 8.

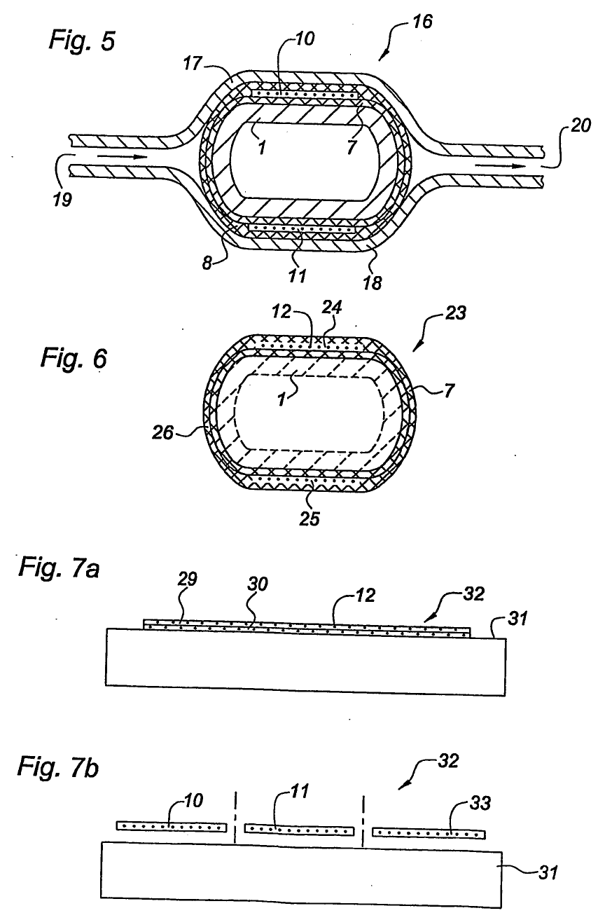

FIG. 5 shows a fourth step of the method of the invention in which there is placed the set comprising the support 1, the parts 10 and 11, and the dry preform 8 in a tubular mold 16. This mold 16 has two parts 17 and 18 which are placed flat against the preform 8. These parts 17 and 18 thus sandwich the set of dry fibers 7 of the preform 8 and of the pre-impregnated parts 10 and 11.

The parts 17 and 18 of the mold 16 respectively comprise apertures 19 and 20 through which a second resin used for the RTM method is injected. The aperture 19 corresponds to the inlet aperture for the second resin while the aperture 20 corresponds to the outlet aperture for the second resin. The second resin thus spreads uniformly inside the mold 16. More specifically, this second resin spreads in the preform 8 in filling the empty zones between the dry fibers 7, impregnating these dry fibers. By contrast, this second resin cannot spread in the pre-impregnated parts 10 and 11 since the first resin already occupies their volume.

After the second resin is injected, the first and second resins are polymerized at the same time. More specifically, the second resin is polymerized completely and the polymerization of the first resin is finished completely. Indeed, during this final polymerization step, the first and second resins are polymerized together for a determined period of time, the first resin being originally at a more advanced stage of polymerization than the second resin. Molecular bonds are then created between these resins and it is no longer possible to discern the contours of the pre-impregnated parts 10 and 11 which melt into the first resin.

Since the first resin is partially pre-polymerized, the fibers 12 of the pre-impregnated parts 10 and 11 do not shift during this final polymerization step. This absence of a shift ensures that the fibers 12 are well-aligned inside the final part.

Preferably, the first and second resins are the same. Should these resins be different, they are chosen so as to present molecular structures that are compatible with each other. Furthermore, if the polymerization is done in heating the resins, resins that have identical or neighboring temperatures of polymerization are chosen. The final polymerization may be done under pressure or under vacuum.

FIG. 6 shows a fifth step of the method of the invention in which the mold 16 is opened to obtain a final composite part 23. This final part 23 has the general shape of the support 1.

At the end of this method, this support 1 may furthermore be either kept within the final part 23 or removed from the center of this part 23.

This final part 23 has a section with first zones 24 and 25 and a distinct second zone 26 having different mechanical characteristics. Indeed, the first zones 24 and 25 have a volume rate of fibers of over 55%. These first zones 24 and 25 correspond respectively to the parts 10 and 11 and therefore comprise fibers that are substantially parallel to one another.

The second zone 26 has a volume rate of fibers generally below 55%. This second zone 26 corresponds to the RTM preform 8 and therefore has interlaced fibers forming angles of plus or minus 45° with the axis of the part.

These parallel fibers 12 oriented along the direction perpendicular to the sheet are designed to support compressive forces, while the fibers 7 oriented at plus or minus 45° are designed to support buckling forces which are applied along a direction other than the one perpendicular to the sheet.

In one particular embodiment, these dry fibers 7 of the preform 8 and the fibers 12 of the parts 10 and 11 are made of carbon, fiberglass, kelvar or ceramic. In this embodiment, the first and second resins are resins based on epoxy, cyanate ester, phenol or polyester.

FIG. 7 show steps of the method of the invention used to make pre-impregnated and pre-polymerized parts 10 and 11.

In a first step shown in FIG. 7a, two stacks (or more) of pre-impregnated and non-polymerized strips 29 and 30 are placed flat against one face of the specific tool set 31 adapted to the making of pre-impregnated parts. The non-polymerized strips 29 and 30 thus take the shape of the support 1 which is essentially flat. Thus, a large pre-impregnated plate 32 that is not polymerized is obtained.

More specifically, each strip 29, 30 comprises fibers 12 that are substantially aligned and parallel to one another in a direction perpendicular to the plane of the sheet. These fibers are pre-impregnated with a first resin which bonds them together. To form a pre-impregnated part, the strips 29, 30 are placed flat against one another so that the fibers of all the strips are substantially parallel to one another. As a variant, the strips 29, 30 are placed flat against each other so that the fibers of a given strip form a particular angle, for example an angle of more or less than 10°, with the fibers of another strip.

After the strips have been positioned, the first resin of the plate 32 is partially polymerized. More specifically, the polymerization is stopped when the resin is rigid enough for the pre-impregnated fibers 12 to be fixed in their position, inside this resin. The pre-impregnated fibers 12 will thus be able to keep their alignment when the subsequent steps of the method of the invention are implemented. The partial polymerization is preferably done within a vacuum-tight and pressurized mold.

In one embodiment, the first resin of the plate 32 is polymerized at a polymerization rate of about 10%. This polymerization rate corresponds to the overall progress of the polymerization and to the setting up of chains of molecules inside the resin. In other embodiments, it will be possible to partially polymerize the first resin at a polymerization rate of 5 to 70%.

Once the first resin has been partially polymerized, the plate 32 is demolded. Thus, the pre-impregnated and pre-polymerized plate 32 is obtained.

Then, as shown in FIG. 7b, the pre-impregnated and pre-polymerized plate 32 is cut out so as to obtain several parts 10, 11, 33. The plate 32 may be cut out directly on the tool set 31 by means of cutting tools adapted to the cutting out of polymerized resin.

The preliminarily making of a large plate 32 of pre-impregnated pre-polymerized materials is economical and gives substantial gains in time. Indeed, it is possible to obtain many pre-impregnated and pre-polymerized parts in performing only one partial polymerization step.

As a variant, it will be possible to position pre-impregnated and non-polymerized strips 29 and 30 on the bare support 1 before performing the step of FIG. 2. The step of partial polymerization of the first resin can then be made in placing the support 1 and the strips within a pressurized mold. It is only after this step that the dry fibrous preform 8 can be positioned about the support 1.

As a variant, the plate 32 is given an undulating shape by having the strips 29 and 30 positioned inside a mold with slightly curved shapes. The parts obtained can thus be placed against the curved sides of the support 1.

1-17. (canceled)

18. A method of manufacturing a resin transfer molding (RTM) composite part, comprising the steps of:
producing a pre-impregnated part comprising substantially of aligned fibers impregnated with a first resin;
partially polymerizing the first resin of the pre-impregnated part at a polymerization rate ranging from 5% to 70% to provide a pre-polymerized part so that rigidity of the first resin is changed to enable the aligned fibers to be fixed in their position inside the first resin;
positioning the pre-polymerized part and a dry fibrous preform about a support, the dry fibrous preform comprising fibrous elements including dry fibers;
injecting a second resin into the dry fibrous preform; and
polymerizing the second resin and simultaneously terminating the step of partially polymerizing the first resin.

19. The method of claim 18, wherein the step of producing comprises the step of forming the pre-impregnated part with strips of fibers superimposed on one another to provide pre-impregnated strips, the fibers of the impregnated part being parallel to one another for each strip.

20. The method of claim 19, wherein the step of positioning comprises the step of positioning the pre-impregnated part between the fibrous elements of the dry fibrous preform.

21. The method of claim 18, wherein the step of positioning comprises the step of positioning the pre-polymerized part between the fibrous elements of the dry fibrous preform.

22. The method of claim 18, wherein the step of injecting comprises the step of injecting the second resin having molecular structures that are compatible with molecular structures of the first resin.

23. The method of claim 22, wherein the step of injecting comprises the step of injecting the second resin having substantially same chemical composition as the first resin.

24. The method of claim 18, wherein the step of injecting comprises the steps of:
placing the support, the pre-polymerized part and the dry fibrous preform inside a mold; and
injecting the second resin inside the mold so that the second resin impregnates the dry fibers of the dry fibrous preform.

25. The method of claim 19, wherein the steps of producing comprises the step of shaping stacks of the pre-impregnated strips before the step of partially polymerizing, the pre-impregnated strips comprising fibers substantially aligned and parallel to each other, and bonded to each other by the first resin; and wherein the step of partially polymerizing comprises the step of partially polymerizing the first resin of the shaped and pre-impregnated stripes.

26. The method of claim 19, wherein the step of partially polymerizing comprises the step of partially polymerizing the first resin under vacuum and under pressure.

27. The method of claim 25, wherein the step of shaping comprises the step of shaping the pre-impregnated strips on a tool set for making pre-impregnated parts.

28. The method of claim 25, wherein the step of shaping comprising the step of shaping the pre-impregnated strips on the support.

29. The method of claim 25, further comprising the step of performing cutting-out or machining operations on the shaped and pre-polymerized strips.

30. The method of claim 18, wherein the step of positioning includes positioning the dry fibrous preform comprising fibrous, stoking-shaped elements including interlaced fibers on the support.

31. The method of claim 30, wherein the step of positioning includes positioning dry fibrous preform comprising fibers interlaced at plus or minus 45 degrees on the support.

32. The method of claim 18, further comprising the step of aligning the aligned fibers of the pre-impregnated and pre-polymerized part in parallel to a direction of a compression force to be applied to a final composite part.

33. A connection rod manufactured from composite materials, comprising:
a preferred axis of compression;
at least two layers of fibrous elements comprising interlaced fibers impregnated with resin after shaping by a resin transfer molding (RTM) method; and
parts made of composite material using fibers pre-impregnated with resin and positioned between the at least two layers of fibrous elements, said parts comprising fibers substantially parallel to one another and oriented substantially along the preferred axis of compression of the connection rod.

34. The connection rod of claim 33, further comprises an elongated tubular support on which said at least two layers of fibrous elements are positioned.
